(19) United States
(12) Patent Application Publication
(10) Pub. No.: US 2015/0332671 A1
(43) Pub. Date: Nov. 19, 2015

(54) DEVICE AND METHOD FOR SPEECH RECOGNITION

(71) Applicant: FORD GLOBAL TECHNOLOGIES, LLC, Dearborn, MI (US)

(72) Inventors: Christoph ARNDT, Moerlen Rheinland-Pfalz (DE); Uwe GUSSEN, Huertgenwald (DE); Frederic STEFAN, Aachen (DE)

(21) Appl. No.: 14/712,752

(22) Filed: May 14, 2015

(30) Foreign Application Priority Data
May 16, 2014 (DE) 10 2014 209 358.9

(51) Int. Cl. G10L 15/07; G10L 25/66; G10L 25/63

(52) U.S. Cl. CPC G10L 15/075; G10L 25/63; G10L 25/66

(57) ABSTRACT

A device and a method for speech recognition, usable in a vehicle, with a processing unit for processing audio signals of a user on the basis of a user speech profile assigned to this user. The device is configured to store the user speech profile in an external memory assigned only to this user and located outside the processing unit, and to automatically retrieve the user speech profile stored in the external memory at each start-up of the device. The automatically retrieved user speech profile is communicated to the processing unit for use in the processing of future audio signals of the user.

### CROSS-REFERENCE TO RELATED APPLICATIONS

This application claims foreign priority benefits under 35 U.S.C. §119(a)-(d) to DE 10 2014 209 358.9 filed May 16, 2014, which is hereby incorporated by reference in its entirety.

### TECHNICAL FIELD

The invention relates to a device and a method for speech recognition.

### BACKGROUND

Known speech-recognition systems preferably use a given speech profile associated with a specific user, in order to be able to process audio signals of the specific user. In this connection, the phonemes as spoken by the user in question are identified, so that the recognition of the phonemes can be effected in conformity with the user or the manner of speaking or speech sample of said user. Phonemes constitute the smallest meaning-distinguishing units of sound of a language. Use is made of about 40 different phonemes in the German language, for example.

The identification of the phonemes is typically effected using diverse filters, via which the respective input signals are processed with differing frequency limits and time limits. The results are used as parameters in the speech-recognition system, use being made, for example, of a hidden Markov model (HMM) or of artificial neural networks. As a result, a specific response to the user in question and adaptation can be effected to the respective pronunciation of said user and also to any possible peculiarities of speech such as, for example, a dialect or accent, the pronunciation of a native speaker etc.

When utilising speech-recognition systems the problem may arise that, as a rule, when starting to use a new system a certain time is needed for the adaptation to the user, which may be referred to as a learning phase. The learning phase, particularly in the case of speech recognition in a vehicle for example, may be laborious or annoying when this adaptation has to be effected all over again at each start-up or restart of a vehicle. In addition, the requisite learning phase is arduous for the user, inasmuch as the user repeatedly has to issue commands where appropriate, or finds himself/herself exposed to incorrect or undesirable system responses, it being also possible that it will be necessary to issue a series of commands repeatedly from time to time.

### SUMMARY

In an embodiment disclosed herein, a speech recognition device is operative to automatically retrieve via a two-way wireless communication link a speech profile associated with a user stored in a memory unit external to the device, and use the speech profile to process audio signals of the user

According to further embodiments, the memory unit comprises a portable memory device adapted to be carried by and/or on the user, or comprises a memory area in a cloud server.

In a further embodiment disclosed herein, a speech recognition system comprises a speech recognition device and a memory unit located external to the device and having stored therein a speech profile of a user. The device is operative to automatically retrieve, via a wireless communication link, the profile from the memory unit at a start-up of the system for use in processing of audio signals of the user

According to a further embodiment, a method for speech recognition comprises storing a speech profile associated with a user in a memory unit; operating a speech recognition device to automatically retrieve, via a two-way wireless communication link, the speech profile at a start-up of the device; and operating the device to process audio signals received from the user.

The invention will be explained in more detail below with reference to an exemplary embodiment represented in the appended illustration.

### BRIEF DESCRIPTION OF THE DRAWINGS

FIG. 1 shows a schematic representation features of the speech recognition system disclosed herein used in association with a motor vehicle; and

FIG. 2 shows a flow chart of a speech recognition method disclosed herein.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

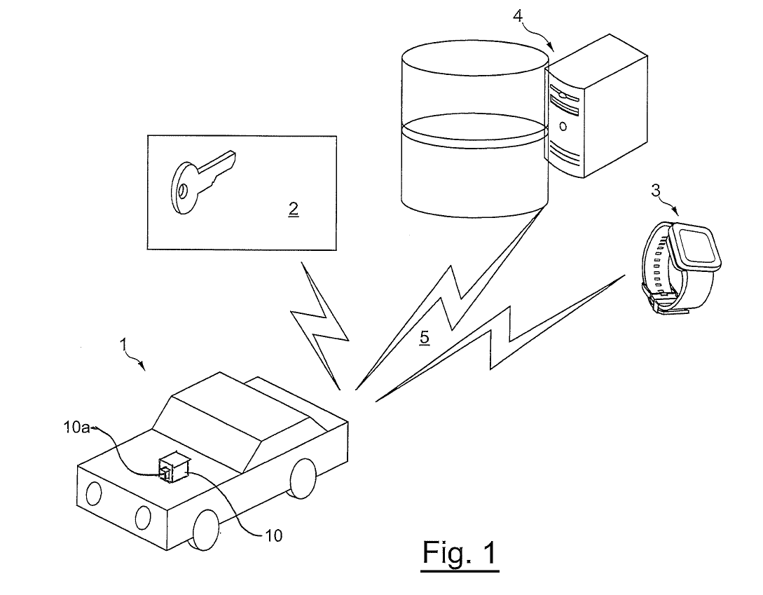

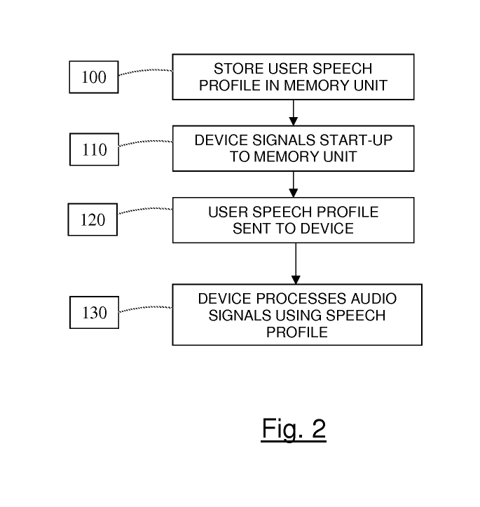

A speech recognition device 10 includes a processing unit 10a for processing audio signals of a user on the basis of a user speech profile assigned to this user. This speech recognition device 10 may, according to FIG. 1 for example, be provided in a vehicle 1. The processing unit 10a is operative, in a manner known in the art, to process audio signals generated from the spoken voice of a user (in this case, a vehicle occupant and/or driver) on the basis of a user speech profile (FIG. 2, step 130), phonemes of the user being likewise identified in a manner known in the art, and adaptation of the speech recognition to the user in question being effected.

The speech profile is stored (FIG. 2, step 100) in an external memory unit assigned only to this user and located external to the processing unit (that is to say, to a certain extent, in a ‘personalised system’ or ‘personalised memory’). The personalised device may be, for example as indicated in FIG. 1, a key or key-ring pendant 2 equipped with a memory function, or a memory device carried by a user or worn on the user's body, such as, for instance, a memory wristband 3. In a further embodiment, the external memory unit can comprise a memory area of a cloud server 4.

The speech profile stored in the personalised device or personalised external memory 2,3,4 is retrieved from the memory unit at each start-up of the speech recognition device 10, which may correspond to a start-up an engine, motor, or electrical system of the vehicle 1, and is transmitted to the device using a two-way wireless link 5 for the communication of data. The wireless link 5 may be, as is well known in the art, a wireless communications network.

The speech profile for storage may be transmitted to the memory unit from the device 10 via the wireless link 5.

Retrieval of the speech profile may comprise the device 10 sending a signal (FIG. 2, step 110) to the external memory unit via the two-way wireless link 5, the signal indicating a “start-up” condition of the device. The memory unit responds to the start-up signal by transmitting the saved speech profile to the device (FIG. 2, step 120) via the wireless link 5.

The transfer of data via the wireless link can be restricted to a limited number of phonemes, in order to avoid exceeding the capacity of the respective communication channels or data-transmission channels.

During operation continuous adaptation of the phonemes can be effected, in order, for example, to take into account any possible changes in the time/frequency characteristic of the pronunciation of the user or driver in question. Automatic adaptation of the user speech profile can also be effected if excessive changes or deviations arise between the stored speech samples and the current speech samples of the respective user (for example, as a consequence of a physical and/or mental state of the user such as stress, tiredness or illness), or if an increasingly restricted separation of consecutive phonemes and/or a lower rate of recognition are/is detected, for instance as a consequence of an illness or overtiredness of the user or driver.

In embodiments of the invention the physical and/or mental condition of the user can also be inferred on the basis of the respective deviations between the stored speech samples and the current speech samples of the user in question, it also being possible to generate or support appropriate warnings (for example, with regard to overtiredness of the driver).

In further embodiments of the invention a certain set of phonemes based on the previously ascertained condition of the driver (for example, ‘ill’, ‘stressed’, ‘overtired’, ‘normal’ etc.) can also be selected automatically and ‘intelligently’, prior acquisition of the condition of the driver being possible in this case (for example, on the basis of a spectral and/or cepstral analysis).

A concept underlying the system and method disclosed herein to store a user speech profile, which comprises previously learnt parameters (phonemes) relating to the pronunciation or the speech sample of a certain user, in an external memory assigned only to this user and located outside the processing unit (which, to a certain extent, constitutes a ‘personalised system’ or ‘personalised memory’). This personalised system then transmits the parameters in question to the processing unit of the device for speech recognition at each start-up (that is to say, for example, in particular after the start of the engine, motor, and/or electrical system of a motor vehicle), so that the need for repeated ‘training’ of the device for speech recognition ceases to apply.

The user speech profile stored in the external memory can furthermore be constantly adapted in an advantageous manner if, for example, significant or excessive differences arise between the speech samples contained in the stored user speech profile and the currently detected speech behavior of the user in the given case. Such changes may be attributable, for example, to stress, tiredness or illness of the user. Such adaptations can be effected particularly rapidly, since after the user speech profile is first stored, a base set of previously learnt phonemes is already available and merely has to be retrieved from the external memory or the personalised system at each renewed system start. Any possible amendments or adaptations can be carried out in a ‘subspace’ or subset of the actual ‘phoneme space’, this subspace being substantially smaller than the ‘phoneme space’ available overall, so that the adaptation can be effected substantially more rapidly and, for the user, almost imperceptibly.

Since the external memory or personalised system, in which the learnt speech parameters or phonemes (i.e. the respective user speech profile) are stored, and from which they are retrieved at each start-up, is a portable appliance, it is possible to adapt any compatible speech-recognition system—and also, for example, any vehicle equipped with such a system—to the user in question by utilising the respective parameters. Consequently, there is no restriction, for instance to a certain vehicle, but rather the respective adaptation and also the corresponding speech recognition can also be effected at any time in any other vehicle in a manner that is robust, reliable and also convenient for the respective user. This permits, in particular, application in hired vehicles, in company vehicles, in the case of so-called car sharing, etc., when such vehicles are equipped with a speech recognition device. In this case the respective speech-recognition system is enabled to obey the respective commands of the driver or user directly and conveniently without a prior training phase.

The disclosed method/system can be implemented without additional hardware expenditure and associated costs, since data-transfer modules which are already available can be utilised, and the processing of the respective phonemes is already an integral part of the respective existing speech-recognition system.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A speech recognition device operative to:
automatically retrieve via a two-way wireless communication link a speech profile associated with a user stored in a memory unit external to the device; and
use the speech profile to process audio signals of the user.

2. The device of claim 1, wherein the memory unit comprises a portable memory device adapted to be carried by and/or on the user.

3. The device of claim 1, wherein the memory unit comprises a memory area in a cloud server.

4. The device of claim 1, further operative to carry out the storing of the speech profile via the wireless communication link.

5. The device of claim 1, further operative to carry out the storing and retrieving of the speech profile in encrypted form.

6. The device of claim 1, further operative to carry out automatic adaptation of the speech profile to a current speech sample of the user.

7. The device of claim 1, further operative to adapt the speech profile as a function of a current physical and/or mental state of the user.

8. A system comprising:
a speech recognition device; and
a memory unit located external to the device and having stored therein a speech profile of a user, the device operative to automatically retrieve, via a wireless communication link, the profile from the memory unit at a start-up of the system for use in processing of audio signals of the user.

9. The system of claim 8, wherein the memory unit comprises a portable memory device adapted to be carried by and/or on the user.

10. The system of claim 8, wherein the memory unit comprises a memory area in a cloud server.

11. The system of claim 8, further operative to carry out the storing of the speech profile via the wireless communication link.

12. The system of claim 8, further operative to carry out the storing and retrieving of the speech profile in encrypted form.

13. The system of claim 8, further operative to carry out automatic adaptation of the speech profile to a current speech sample of the user.

14. The system of claim 8, further operative to adapt the speech profile as a function of a current physical and/or mental state of the user.

15. A method for speech recognition, comprising:
storing a speech profile associated with a user in a memory unit;
operating a speech recognition device to automatically retrieve, via a two-way wireless communication link, the speech profile at a start-up of the device; and
operating the device to process audio signals received from the user.

16. The method of claim 15, wherein the memory unit comprises a portable memory device adapted to be carried by and/or on the user.

17. The method of claim 15, wherein the memory unit comprises a memory area in a cloud server.

18. The method of claim 15, wherein the speech profile is transmitted to the memory unit for storing via the wireless communication link.

19. The method of claim 15, wherein the speech profile is stored and retrieved in encrypted form.

20. The method of claim 15, further comprising automatically adapting the speech profile to a current speech sample of the user.
